(19) United States
(12) Patent Application Publication
(10) Pub. No.: US 2026/0178482 A1
(43) Pub. Date: Jun. 25, 2026

(54) Method for M.2 SSD hot plug process, electronic device, storage medium, and program product

(71) Applicant: INNOGRIT TECHNOLOGIES CO., LTD., Shanghai (CN)

(72) Inventors: Lily RUI, Shanghai (CN); Zining WU, Shanghai (CN)

(21) Appl. No.: 19/279,152

(22) Filed: Jul. 24, 2025

Related U.S. Application Data
(60) Provisional application No. 63/675,871, filed on Jul. 26, 2024.

(51) Int. Cl. G06F 12/02

(52) U.S. Cl. CPC G06F 12/0246

(57) ABSTRACT

The present disclosure relates to an M.2 SSD hot plug/unplug processing method, an electronic device, a storage medium, and a program product, the method includes: a determining step of determining, according to a power identifier of a first M.2 SSD plugged into a target apparatus, whether a hot unplug operation is required to be performed on the first M.2 SSD; a processing step of causing, if it is determined that a hot unplug operation is required to be performed on the first M.2 SSD, the first M.2 SSD to enter a read-only mode, and continuing to complete a writing operation for an old writing request been received from the target apparatus; and a prompting step of prompting a user that a hot unplug operation can be currently performed on the first M.2 SSD. Therefore, the M.2 SSD hot plug/unplug can be achieved in a more reliable and safe manner.

### CROSS-REFERENCE TO RELATED APPLICATIONS

This application claims the benefit of priority to U.S. provisional application 63/675,871, filed on Jul. 26, 2024. The disclosure of the aforementioned patent application is hereby incorporated by reference in its entirety.

### TECHNICAL FIELD

The present disclosure relates to the field of hot plug/unplug technologies, and in particular, to an M.2 SSD hot plug/unplug processing method, an electronic device, a storage medium, and a program product.

### BACKGROUND

In some applications of M.2 SSD (Solid State Disk), such as applying M.2 SSD to a NVMe (non-volatile memory express, non-volatile memory host controller interface specification) RAID (redundant arrays of independent disks) card, there is a need of M.2 SSD hot plug/unplug. That is, when applying M.2 SSD to an NVMe RAID card, there is a need to directly unplug a failed M.2 SSD and plug in a new or standby M.2 SSD without shutting down the system or turning off the power source.

However, M.2 SSD itself does not support hot plug/unplug. If M.2 SSD is forced to be hot plug/unplugged, there is a high probability of hard disk damage and data loss, therefore, the existing M.2 protocol itself cannot ensure the reliability of M.2 SSD hot plug/unplug, probably leading to problems such as hard disk damage and data loss during the hot plug/unplug of the M.2 SSD.

Therefore, one of the problems to be solved is how to implement M.2 SSD hot plug/unplug in a more reliable and safe manner.

### SUMMARY

In view of this, the present disclosure provides an M.2 SSD hot plug/unplug processing method, an electronic device, a storage medium, and a program product, so that M.2 SSD hot plug/unplug can be implemented in a more reliable and safe manner.

According to a first aspect of the present disclosure, an M.2 SSD hot plug/unplug processing method is provided, including: a determining step of determining, based on a power identifier of a first M.2 SSD plugged in a target apparatus, whether a hot unplug operation is required to be performed on the first M.2 SSD; a processing step of causing, if it is determined that a hot unplug operation is required to be performed on the first M.2 SSD, the first M.2 SSD to enter a read-only mode indicating that the first M.2 SSD cannot receive a new writing request from the target apparatus, and continuing to complete a writing operation for an old writing request that has been received from the target apparatus; and a prompting step of prompting a user that a hot unplug operation can be currently performed on the first M.2 SSD.

In a possible implementation, the determining step includes: obtaining a power identifier of the first M.2 SSD in real time; determining whether a value of a currently obtained power identifier is a first value indicating that a hot unplug operation is required to be performed on the first M.2 SSD; and if it is determined that the value of the obtained power identifier is the first value, determining that the hot unplug operation is required to be performed on the first M.2 SSD.

In a possible implementation, the determining step includes: obtaining a power identifier of the first M.2 SSD in real time; determining whether a value of a currently obtained power identifier is consistent with a value of a power identifier that is set for the first M.2 SSD when a power-on initialization is performed on the first M.2 SSD; and if the values are inconsistent, determining that a hot unplug operation needs to be performed on the first M.2 SSD.

In a possible implementation, the processing step includes: if it is determined that a hot unplug operation needs to be performed on the first M.2 SSD, enabling the first M.2 SSD to enter the read-only mode, and determining whether first data written into a temporary storage module exists in data corresponding to the old write request; and if it is determined that the first data exists, writing the first data stored in the temporary storage module into a flash memory of the first M.2 SSD, to continue to complete a write operation for the old write request, where the prompting step is performed after the write operation for the old write request is completed.

In a possible implementation, the prompting step includes: after the writing operation for the old writing request is completed, causing the first M.2 SSD to enter a quasi-hot unplug mode from the read-only mode, and performing the prompting, wherein the quasi-hot unplug mode is a mode indicating that data cannot be written into the first M.2 SSD and awaiting hot unplugging of the first M.2 SSD from the target apparatus by the user.

In a possible implementation, the power identifier of the first M.2 SSD includes a power status bit indicating a power status of the first M.2 SSD, and correspondingly, the method further includes: switching the power status bit of the power identifier of the first M.2 SSD in response to the user turning off the power switch associated with the first M.2 SSD based on the prompt.

In a possible implementation, the prompt includes at least one of: lighting up an indicator light associated with the first M.2 SSD; causing an acoustic component associated with the first M.2 SSD to emit a prompting tone; causing a vibration component associated with the first M.2 SSD to vibrate; notifying a user that a hot unplug operation can be performed on the first M.2 SSD; and displaying, to the user, an event that a hot unplug operation can be performed on the first M.2 SSD.

In a possible implementation, the method further includes: generating, in response to that a power switch associated with a second M.2 SSD that is newly hot plugged in the target apparatus is turned on, a power identifier of the second M.2 SSD is generated and recorded based on the hard disk information of the second M.2 SSD and the power status of the second M.2 SSD, where a current value of the power identifier of the second M.2 SSD is a second value indicating that the second M.2 SSD works normally; and then performing the determining step on the second M.2 SSD.

In a possible implementation, the power identifier of the second M.2 SSD includes a power status bit indicating a power status of the second M.2 SSD, wherein the power status bit in the power identifier of the second M.2 SSD is switched in response to a change of the power status of the second M.2 SSD.

In a possible implementation, the target apparatus includes an NVMe RAID card or a host.

According to a second aspect of the present disclosure, an M.2 SSD hot plug/unplug processing device is provided, including: a determining module, configured to determine, based on a power identifier of a first M.2 SSD plugged in a target apparatus, whether a hot unplug operation is required to be performed on the first M.2 SSD; a processing module, configured to cause, if the determining module 710 determines that a hot unplug operation is required to be performed on the first M.2 SSD, the first M.2 SSD to enter a read-only mode indicating that the first M.2 SSD cannot receive a new writing request from the target apparatus, and continue to complete a writing operation for an old writing request that has been received from the target apparatus; and a prompting module, configured to prompt a user that a hot unplug operation can be currently performed on the first M.2 SSD.

In a possible implementation, the determining module is configured to: obtain a power identifier of the first M.2 SSD in real time; determine whether a currently obtained value of the power identifier is a first value indicating that a hot unplug operation needs to be performed on the first M.2 SSD; and if it is determined that the obtained value of the power identifier is the first value, determine that the hot unplug operation needs to be performed on the first M.2 SSD.

In a possible implementation, the determining module is configured to: obtain a power identifier of the first M.2 SSD in real time; determine whether a value of a currently obtained power identifier is consistent with a value of a power identifier that is set for the first M.2 SSD during power-on initialization of the first M.2 SSD; and if the values are inconsistent, determine that a hot unplug operation needs to be performed on the first M.2 SSD.

In a possible implementation, the processing module is configured to: if it is determined that a hot unplug operation needs to be performed on the first M.2 SSD, enable the first M.2 SSD to enter the read-only mode, and determine whether first data written into a temporary storage module exists in data corresponding to the old write request; and if it is determined that the first data exists, write the first data stored in the temporary storage module into a flash memory of the first M.2 SSD, to continue to complete a write operation for the old write request, where after the write operation for the old write request is completed, the prompt module prompts a user that a hot unplug operation can be currently performed on the first M.2 SSD.

In a possible implementation, the prompt module is configured to: after the writing operation for the old writing request is completed, cause the first M.2 SSD to enter a quasi-hot unplug mode from the read-only mode, and perform the prompting, wherein the quasi-hot unplug mode is a mode indicating that data cannot be written into the first M.2 SSD and awaiting hot unplugging of the first M.2 SSD from the target apparatus by the user.

In a possible implementation, the power identifier of the first M.2 SSD includes a power status bit indicating a power status of the first M.2 SSD, and correspondingly, the processing module is further configured to switch the power status bit of the power identifier of the first M.2 SSD in response to the user turning off the power switch associated with the first M.2 SSD based on the prompt.

In a possible implementation, the prompt includes at least one of the following: lighting an indicator light associated with the first M.2 SSD; enabling a sound component associated with the first M.2 SSD to emit a prompting tone; causing a vibration component associated with the first M.2 SSD to vibrate; notifying a user that a hot unplug operation can be performed on the first M.2 SSD; and displaying, to the user, an event that a hot unplug operation can be performed on the first M.2 SSD.

In a possible implementation, the above device further includes: a generating module, configured to: in response to a power switch associated with the a second M.2 SSD that is newly hot plugged in the target apparatus being turned on, generate and record a power identifier of the second M.2 SSD based on the hard disk information of the second M.2 SSD and the power status of the second M.2 SSD, wherein a current value of the power identifier of the second M.2 SSD is a second value indicating that the second M.2 SSD works normally; and then the determining module performs the above determination on the second M.2 SSD.

In a possible implementation, the power identifier of the second M.2 SSD includes a power status bit indicating a power status of the second M.2 SSD, wherein the power status bit in the power identifier of the second M.2 SSD is switched in response to a change of the power status of the second M.2 SSD.

According to a third aspect of the present disclosure, an electronic device is provided, including a memory, a processor, and computer program stored on the memory, the processor executes the computer program to implement the steps of the above method.

According to a fourth aspect of the present disclosure, there is provided a non-volatile computer-readable storage medium having computer program stored thereon that, when executed by a processor, implements the steps of the above method.

According to a fifth aspect of the present disclosure, there is provided a computer program product including computer program or a non-volatile computer-readable storage medium carrying computer program, wherein the computer program implements, when executed by a processor, the steps of the above method.

M.2 SSD hot plug/unplug processing method, electronic device, storage medium and program product of the present disclosure determine whether there is a need of hot unplug for a M.2 SSD that is plugged in a target apparatus based on a power identifier of the M.2 SSD; and cause, if there is a need of hot unplug, the M.2 SSD to enter a read-only mode indicating that the M.2 SSD cannot receive a new writing request from the target apparatus, and to continue to complete a writing operation for an old writing request that has been received from the target apparatus, and prompts the user that a hot unplug operation can be currently performed on the M.2 SSD; therefore, compared with a forcible unplugging of the M.2 SSD being plugged in the target apparatus, by the present disclosure, the user can know which one M.2 SSD should be hot unplug from the prompt, turn off the power source of that M.2 SSD, and hot unplug the M.2 SSD from the target apparatus; for this it is possible to avoid damaging the hard disk during the hot plug/unplug of the M.2 SSD, and the writing operation for the old writing request has been completed before the hot unplug of the M.2 SSD from the target apparatus; by this it is possible to avoid data loss during the hot plug/unplug of the M.2 SSD, so that the hot plug/unplug of the M.2 SSD can be implemented in a more reliable and safe manner.

Other features and aspects of the present disclosure will become apparent from the following detailed description of exemplary embodiments with reference to the accompanying drawings.

### BRIEF DESCRIPTION OF THE DRAWINGS

The accompanying drawings, which are incorporated in and constitute a part of this specification, illustrate exemplary embodiments, features, and aspects of the present disclosure together with the description, and serve to explain the principles of the present disclosure.

FIG. 1 shows a flowchart of an M.2 SSD hot plug/unplug processing method according to an embodiment of the present disclosure.

FIG. 2 shows a schematic diagram of an M.2 SSD hot unplug process according to an embodiment of the present disclosure.

FIG. 3 shows a schematic diagram of a determining step of the M.2 SSD hot plug/unplug processing method according to an embodiment of the present disclosure.

FIG. 4 shows a schematic diagram of a determining step of the M.2 SSD hot plug/unplug processing method according to an embodiment of the present disclosure.

FIG. 5 shows a flowchart of an M.2 SSD hot plug/unplug processing method according to an embodiment of the present disclosure.

FIG. 6 shows a schematic diagram of an M.2 SSD hot plug process according to an embodiment of the present disclosure.

FIG. 7 shows a block diagram of an M.2 SSD hot plug/unplug processing apparatus 700 according to an embodiment of the present disclosure.

### DETAILED DESCRIPTION

Various exemplary embodiments, features and aspects of the present disclosure will be described in detail below with reference to the accompanying drawings. The same reference numerals in the drawings indicate elements with the same or similar functions. While the various aspects of the embodiments are presented in drawings, the drawings are not necessarily drawn to scale unless specifically indicated.

As used herein, the terms “comprising,” “including,” “having,” or variants thereof are open-ended and include one or more stated features, integers, elements, steps, components or functions, but do not exclude the presence or addition of one or more other features, integers, elements, steps, components, functions or groups thereof.

When an element is referred to as being “connected”, “coupled”, “responsive”, or variants thereof, to another element, it can be directly connected, coupled, or responsive to another element, or intervening elements may be present.

Although the terms of first, second, third, etc. may be used herein to describe various elements/operations, these elements/operations should not be limited by these terms. These terms are only used to distinguish one element/operation from another. Thus, a first element/operation in some embodiments could be referred to as a second element/operation in other embodiments, without departing from the teachings of the principles of the present disclosure.

The dedicated word “exemplary” is used herein to mean “serving as an example, embodiment, or illustration.” Any embodiment described herein as “exemplary” is not necessarily to be construed as preferred or advantageous over other embodiments.

Furthermore, in the embodiments numerous specific details are set forth for better explanation on the present disclosure. Those skilled in the art should understand that the present disclosure can also be implemented without certain specific details. In some examples, methods, means, elements and circuits well known to those skilled in the art are not described in detail, so as to highlight the subject matter of the present disclosure.

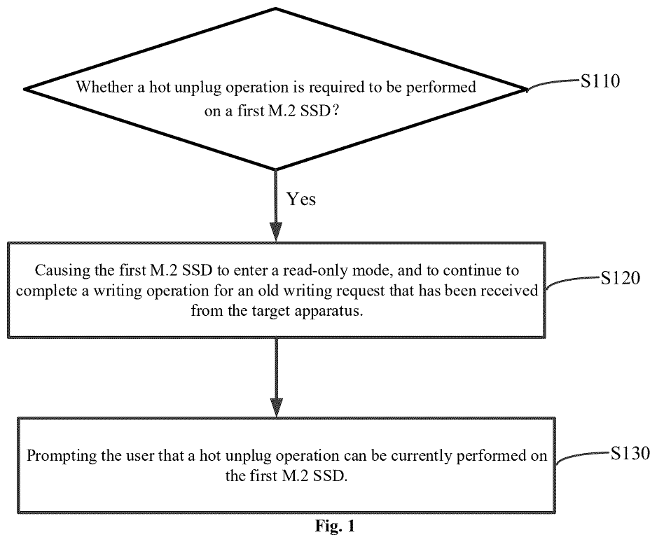

FIG. 1 shows a flowchart of an M.2 SSD hot plug/unplug processing method according to an embodiment of the present disclosure. It should be understood that hot-plug/unplug (hot-plugging) is live plugging and unplugging, and a hot-plug/unplug function refers to the allowance of taking out and replacing a damaged component such as a hard disk, a power source, and a board by a user without shutting down a system and without cutting off a power supply, thereby improving a timely recovery capability, scalability, and flexibility of the system in case of a disaster. In this embodiment, the user can take out the damaged or to-be-replaced M.2 SSD and replace with a new M.2 SSD without shutting down the system and cutting off the power supply, that is, replace the M.2 SSD while ensuring that the system is not powered off. In a possible implementation, the method is performed by a hard disk management program.

As shown in FIG. 1, the method may include the following steps.

In step S110 (determining step), it is determined whether a hot unplug operation is required to be performed on a first M.2 SSD based on the power identifier of the first M.2 SSD plugged in the target apparatus.

In this embodiment, the target apparatus may include but is not limited to an NVMe RAID card or a host. The solution of this embodiment is described below by taking the NVMe RAID card as an example, and this solution is also applicable to the host, so the solution of this embodiment will not be repeated when the target apparatus is the host.

A RAID card is a card providing a RAID function; the first M.2 SSD represents any M.2 SSD plugged in the RAID card, and the power identifier is information capable of indicating whether there is a need of hot unplug for that M.2 SSD; for example, the power identifier is a code. When an M.2 SSD is plugged in the RAID card, a power-on initialization will be performed on that M.2 SSD, and in the power-on initialization a corresponding power identifier is set for the M.2 SSD, and the current value of the power identifier may be referred to as an initial value of the power identifier, for example, a code “0001” indicating that the M.2 SSD works normally is set as the initial value of the power identifier, and the value of the power identifier may further include a code “0010” indicating that there is a need of hot unplug of the block M.2 SSD; that is, when the application program issues an instruction to notify that a hot unplug operation is to be executed next for the M.2 SSD, the value of the power identifier of the M.2 SSD changes from the initial value “0001” to “0010”. A different power identifier is set for each of the M.2 SSDs plugged in the RAID card; in other words, each of the M.2 SSD plugged in the RAID card has a unique power identifier.

It should be noted that, any information can be used as the power identifier in this embodiment, as long as the information can indicate whether there is a need of hot unplug of the M.2 SSD plugged in the RAID card; therefore, this embodiment does not limit the specific information and/or format of the power identifier.

In this embodiment, the power identifier of each M.2 SSD plugged in the NVMe RAID card may be monitored in real time, and it is determined whether the hot unplug operation needs to be performed on the M.2 SSD based on whether or not the power identifier has changed, so as to determine whether the system/administrator plans to hot unplug the M.2 SSD. If the power identifier of a certain M.2 SSD plugged in changes, it can be determined that a hot unplug operation needs to be performed on the M.2 SSD; that is, there is a need of hot unplug of the M.2 SSD; and then the following step S120 may be executed. If the power identifier of the certain M.2 SSD plugged in has not changed, it can be determined that there is no need to perform a hot unplug operation on the block M.2 SSD; that is, there is no need of hot unplug of the M.2 SSD; and in this case, the method may return to step S110 and perform it again.

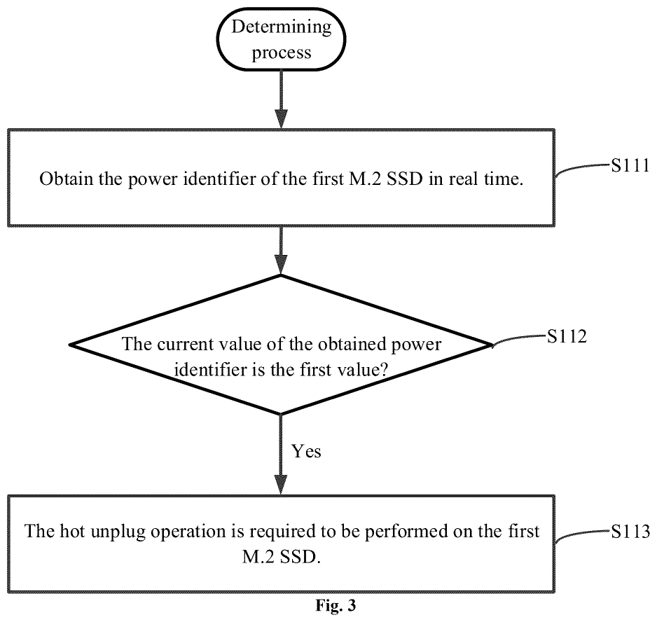

In a possible implementation, as shown in FIG. 3, step S110 may include:

In step S111, the power identifier of the first M.2 SSD is obtained in real time.

In step S112, it is determined whether a value of the currently obtained power identifier is a first value indicating that the hot unplug operation needs to be performed on the first M.2 SSD, such as “0010”.

In step S113, if it is determined that the obtained value of the power identifier is the first value, it is determined that the hot unplug operation is required to be performed on the first M.2 SSD.

In this embodiment, it can be monitored in real time whether the value of the power identifier of each M.2 SSD plugged in the RAID card is the first value, and determine the M.2 SSD whose value of the power identifier is the first value as the M.2 SSD for which the need of hot unplug exists.

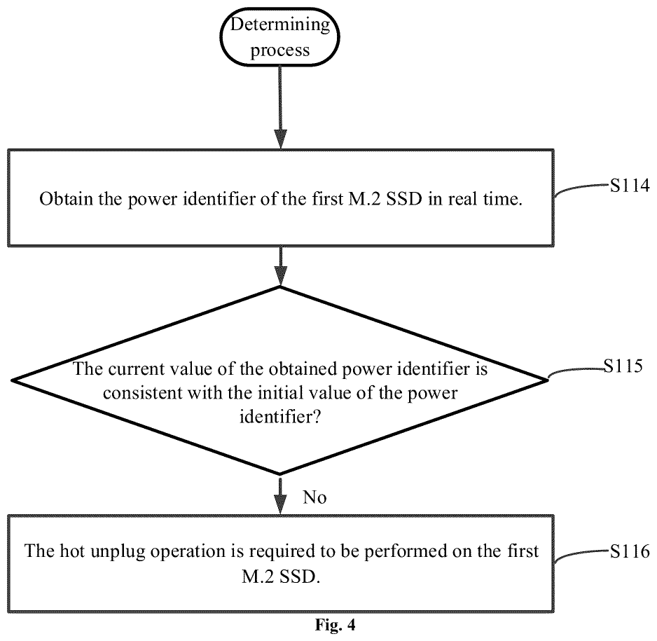

In a possible implementation, as shown in FIG. 4, step S110 may include:

In step S114, the power identifier of the first M.2 SSD is obtained in real time.

In step S115, it is determined whether a value of the currently obtained power identifier is consistent with the value of the power identifier set for the first M.2 SSD upon power-on initialization of the first M.2 SSD, such as “0001”.

In step S116, if they are determined to be inconsistent, it is determined that the hot unplug operation is required to be performed on the first M.2 SSD.

In this embodiment, it can be monitored in real time whether the value of the power identifier of each M.2 SSD plugged in the RAID card is consistent with the initial value of the power identifier of the M.2 SSD, and determine the M.2 SSD whose value of the power identifier is inconsistent with the initial value of its power identifier as the M.2 SSD for which the need of hot unplug exists.

It should be noted that, any manner can be used to implement step S110, as long as it can be determined whether there is a need of hot unplug of the M.2 SSD plugged in the RAID card based on the power identifier of the M.2 SSD; in other words, the present disclosure does not limit how to determine whether there is a need of hot unplug of the M.2 SSD plugged in the RAID card based on the power identifier of the M.2 SSD, and the above is only an example; and those skilled in the art can also determine whether there is a need of hot unplug of the M.2 SSD plugged in the RAID card based on the power identifier of the M.2 SSD in any other suitable manner.

In a possible implementation, the power identifier of the first M.2 SSD includes a power status bit indicating a power status of the first M.2 SSD, and correspondingly, the method further includes: switching the power status bit of the power identifier of the first M.2 SSD in response to the user turning off the power switch associated with the first M.2 SSD based on the prompt.

In this embodiment, considering that the power switch associated with the M.2 SSD newly hot-plugged in the RAID card has changed from off to on, correspondingly, the power status of the M.2 SSD changes from an off status to an on status, and the power switch associated with the M.2 SSD been hot unplugged from the RAID card has changed from on to off, correspondingly, the power status of the M.2 SSD changes from an on status to an off status; therefore, no matter a hot plug or a hot unplug is performed on the M.2 SSD, its power status changes accordingly; therefore, the power identifier of each M.2 SSD includes a power status bit; once the power status of a certain M.2 SSD has changed, the power status bit of the M.2 SSD changes, and correspondingly, the power identifier of the M.2 SSD changes accordingly, so that it can be determined whether there is a need of hot unplug of the M.2 SSD plugged in the RAID card based on the power identifier including the power status bit.

In step S120 (processing step), causing the first M.2 SSD to enter a read-only mode indicating that the first M.2 SSD is unable to receive new writing requests from the target apparatus, and to continue to complete a writing operation for an old writing request that has been received from the target apparatus.

In this embodiment, for an M.2 SSD for which a need of hot unplug exists, the working mode of the M.2 SSD is switched to a read-only mode in which data can be only read from the M.2 SSD but no new data can be written into the M.2 SSD (that is, new data cannot be written into the M.2 SSD); but for old data that has not been processed and corresponds to an old writing request that has been received before the switch to the read-only mode for the M.2 SSD, that is, old data that has been sent to the M.2 SSD but not been processed, the writing processing of the data needs to be continued and completed on the M.2 SSD that has been in the read-only mode. Thus, data loss during the hot unplug of the M.2 SSD can be avoided.

In a possible implementation, step S120 includes: if it is determined that the hot unplug operation is required to be performed on the first M.2 SSD, causing the first M.2 SSD to enter a read-only mode, and determining in the data corresponding to the old writing request whether there is a first data written into a temporary storage module; and if it is determined that the first data exists, writing the first data stored in the temporary storage module into the flash memory of the first M.2 SSD, to continue to complete the writing operation for the old writing request.

In this embodiment, if the SSD is configured with a buffer module for temporarily buffering data, the buffer module may be directly used as a buffer. In this way, after receiving the writing request, the SSD controller first writes data corresponding to the writing request into the buffer module configured in the SSD, and then writes the data from the buffer module into a non-volatile memory of the SSD, for example, an NAND flash memory. The buffer module configured in the SSD may be a volatile memory, and data buffered in the buffer module is lost after power off, for example, a DRAM, a RAM, an SRAM, etc. For example, an independent DRAM chip may be mounted on a PCB of the SSD, to temporarily store data corresponding to the writing request. An NAND flash memory is a non-volatile storage technology that can save data after power is turned off.

Therefore, for the first M.2 SSD configured with the buffer module, the data corresponding to the old writing request received by the first M.2 SSD before switching to the read-only mode is first buffered to the buffer module, and then written from the buffer module to the flash memory of the first M.2 SSD. However, when the first M.2 SSD is switched to the read-only mode, perhaps not all the data buffered in the buffer module of the first M.2 SSD have been written into the flash memory of the first M.2 SSD, that is, the buffer module of the first M.2 SSD may still have data buffered therein (that is, the above first data). If the first M.2 SSD is hot unplugged when there is still data buffered in the buffer module, the data buffered in the buffer module will be lost and the data in the first M.2 SSD will be damaged.

To this end, it is determined whether there is still data buffered in the buffer module of the first M.2 SSD, and if yes, the data is first written into the flash memory of the first M.2 SSD, and the following step S130 is executed after all the data buffered in the buffer module of the first M.2 SSD has been written into the flash memory of the first M.2 SSD.

If the SSD is not configured with a buffer module for temporarily buffering data, a host memory buffer (HMB) technology may be used, and host memory is used as a buffer through a PCIe interface, that is, the host memory is shared using the HMB technology. In this way, after receiving the writing request, the SSD controller first writes data corresponding to the writing request into the host memory, and then writes the data from the host memory into the NAND flash memory of the SSD. The host memory may be a volatile memory, and data buffered in the host memory is lost after power off, for example, a DRAM, an SRAM, a Cache, and a derivative structure thereof.

Therefore, for the first M.2 SSD in which no buffer module is configured but the host memory is shared, the data corresponding to the old writing request received by the first M.2 SSD before switching to the read-only mode is first buffered to the host memory, and then written from the host memory to the flash memory of the first M.2 SSD. However, when the first M.2 SSD is switched to the read-only mode, perhaps not all the data buffered in the host memory have been written into the flash memory of the first M.2 SSD, that is, the host memory may still have data buffered therein (that is, the above first data). If the first M.2 SSD is hot unplugged while there is still data buffered in the host memory, the data in the first M.2 SSD will be damaged.

To this end, it is determined whether there is still data corresponding to the old writing request received by the first M.2 SSD buffered in the host memory; if yes, the data is first written into the flash memory of the first M.2 SSD; and the following step S130 is performed after all the data corresponding to the old writing request received by the first M.2 SSD buffered in the host memory has been written into the flash memory of the first M.2 SSD.

Certainly, if the SSD is not configured with a buffer module for temporarily buffering data, any other suitable manner for buffer may also be used to buffer the data corresponding to the writing request, and then the buffered data is written into the NAND flash memory of the SSD. An implementation principle for the buffering is similar to that of sharing a host memory using the HMB technology, and will not described herein again.

It should be understood that the above temporary storage module may include, but is not limited to, a buffer module configured in an SSD, a host memory shared by an SSD configured without a buffer module using the HMB technology, and a buffer module corresponding to other buffer technologies used by an SSD configured without a buffer module.

After step S120 is executed, the following step S130 is executed next.

In step S130 (processing step), the user is prompted that a hot unplug operation can be currently performed on the first M.2 SSD.

In this embodiment, after the M.2 SSD for which a need of hot unplug exists has been switched to the read-only mode and the writing operation for the old writing request has been completed, a prompt may be made to inform the user which M.2 SSD needs to be hot unplugged currently.

In a possible implementation, the prompt includes at least one of: lighting up an indicator light associated with the first M.2 SSD; causing an acoustic component associated with the first M.2 SSD to emit a prompting tone; causing a vibration component associated with the first M.2 SSD to vibrate; notifying a user that a hot unplug operation can be performed on the first M.2 SSD; and displaying, to the user, an event that a hot unplug operation can be performed on the first M.2 SSD.

In this embodiment, the way of prompting may include, but is not limited to, lighting up an LED indicator, causing an acoustic component to emit a prompting tone, causing a beeper to vibrate, performing a notification, sending an event, and the like.

In a case that the way of prompting is to light up an LED indicator, the power identifier of the M.2 SSD is associated with a particular power-indicating LED on that M.2 SSD and a power switch; then by lighting up the LED indicator associated with the M.2 SSD for which a need of hot unplug exists, the user can know which M.2 SSD needs to be hot unplugged, and can turn off the power switch associated with the M.2 SSD before hot unplugging the M.2 SSD associated with the lit up LED indicator. Therefore, the power identifier of M.2 SSD cooperates with the LED indicator and the power switch to implement the asynchronous secure plugging/unplugging of the M.2 SSD, so that problems of hard disk damage and data loss during the hot unplug of the M.2 SSD can be avoided as much as possible, and the hot plug/unplug of M.2 SSD can be implemented in a safer and more reliable manner.

It should be understood that, any manner can be used to implement step S130 as long as the user can be prompted which M.2 SSD needs to be hot unplugged currently; so the specific manner of prompting is not limited in this embodiment.

In a possible implementation, step S130 includes: after the writing operation for the old writing request is completed, causing the first M.2 SSD to enter a quasi-hot unplug mode from the read-only mode, and performing the prompting, wherein the quasi-hot unplug mode is a mode indicating that data cannot be written into the first M.2 SSD and hot unplugging of the first M.2 SSD from the NVMe RAID card by the user is waited.

In this embodiment, after step S120 is executed, the working mode of the M.2 SSD is switched to the quasi-hot unplug mode, and the above prompt is performed.

Therefore, in this embodiment, it is determined whether there is a need of hot unplug for a M.2 SSD that is plugged in the NVMe RAID card based on a power identifier of the M.2 SSD, and if there is a need of hot unplug, the M.2 SSD is caused to enter a read-only mode indicating that the M.2 SSD cannot receive a new writing request from the NVMe RAID card, and to continue to complete a writing operation for an old writing request that has been received from the NVMe RAID card, and prompts the user that a hot unplug operation can be currently performed on the M.2 SSD; therefore, compared with a forcible unplugging of the M.2 SSD being plugged in the NVMe RAID card, by the present embodiment, the user can know which one M.2 SSD should be hot unplugged from the prompt, turn off the power source of that M.2 SSD, and hot unplug the M.2 SSD from the NVMe RAID card; for this it is possible to avoid damaging the hard disk during the hot plug/unplug of the M.2 SSD, and the writing operation for the old writing request has been completed before the hot unplug of the M.2 SSD from the NVMe RAID card; by this it is possible to avoid data loss during the hot plug/unplug of the M.2 SSD, so that the hot plug/unplug of the M.2 SSD can be implemented in a more reliable and safe manner.

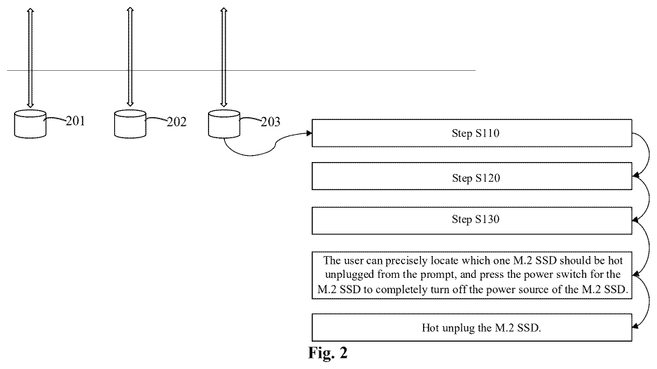

For ease of understanding, a hot unplug process of an M.2 SSD of the present embodiment is described in detail below with reference to FIG. 2. As shown in FIG. 2, in total three M.2 SSDs 201, 202, and 203 are plugged in the NVMe RAID card; and the M.2 SSD 203 is taken as an example to describe a process of hot unplug of any M.2 SSD that has been plugged in the NVMe RAID card.

The hard disk management program monitors whether the power identifier of the M.2 SSD 203 has changed, and if a change is monitored, determines that there is a need of hot unplugging the M.2 SSD 203 from the system, and the system/administrator plans to hot unplug the M.2 SSD 203.

The hard disk management program causes the M.2 SSD 203 to enter the read-only mode and causes the M.2 SSD 203 to continue to complete a writing operation for an old writing request that has been received from the NVMe RAID card. The hard disk management program then causes the M.2 SSD 203 to enter a quasi-hot unplug mode from the read-only mode, prompting the user that the M.2 SSD 203 needs to be hot unplugged. For example, the hard disk management program lights up a hot unplug LED indicator associated with the M.2 SSD 203, to prompt the user that the M.2 SSD 203 associated with the lit up LED indicator needs to be hot unplugged. The quasi-hot unplug mode is a mode in which the M.2 SSD per se cannot be written in anymore, and unplug of the M.2 SSD by the user is waited.

Next, the user can precisely locate the M.2 SSD for which the hot unplug process is required as the M.2 SSD 203 based on the lit up LED indicator, and the user can press the power switch associated with the M.2 SSD 203 to completely turn off the power supply of the M.2 SSD 203. The user then unplugs the M.2 SSD 203 from the RAID card.

By this, compared with a forcible hot unplug of the M.2 SSD 203 from the RAID card in a state that the power supply of the M.2 SSD 203, which is to be hot unplugged, is not turned off, in this embodiment, the power supply of the M.2 SSD 203 is first turned off before the hot unplug of the M.2 SSD 203 from the RAID card; so a problem of hard disk damage during the hot unplug of the M.2 SSD can be avoided. Compared with the case that the M.2 SSD 203 is not caused to enter the read-only mode and the case that the M.2 SSD 203 is not caused to continue to complete the writing operation for the old writing request that has been received from the NVMe RAID card, in this embodiment, the M.2 SSD 203 is hot unplugged from the RAID card after the M.2 SSD 203 is caused to enter the read-only mode and to continue to complete the writing operation for the old writing request that has been received from the NVMe RAID card; so a problem of data loss during the hot unplug of the M.2 SSD can be avoided.

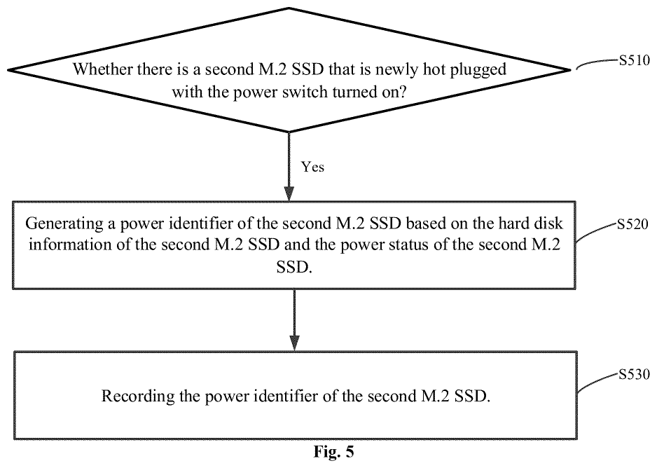

FIG. 5 shows a flowchart of an M.2 SSD hot plug/unplug processing method according to an embodiment of the present disclosure. In a possible implementation, the method is executed by an internal program, such as firmware, in the M.2 SSD. As shown in FIG. 5, the method may include the following steps.

In step S510, it is determined whether there is a second M.2 SSD that is newly hot-plugged with the power switch turned on.

In this embodiment, the second M.2 SSD represents any M.2 SSD that is newly hot plugged in the RAID card; during the running of the user system or the storage system using the M.2 SSD itself, and the likes, the user may have a new M.2 SSD hot plugged in the system. It should be understood that when the user has a new M.2 SSD hot plugged in the system, the M.2 SSD is in a power-off status, and the system cannot detect the plugging of the M.2 SSD. However, in response to the user pressing the power switch associated with the M.2 SSD, i.e. the power switch associated with the M.2 SSD being switched from off to on, the system can detect the plugging of the M.2 SSD, and then execute the following step S520.

In step S520, a power identifier of the second M.2 SSD is generated based on the hard disk information of the second M.2 SSD and the power status of the second M.2 SSD.

In this embodiment, power-on initialization processing may be performed on the newly hot plugged M.2 SSD; the power-on initialization processing includes generating the power identifier of the M.2 SSD based on the hard disk information and the power status of the M.2 SSD.

As described above, upon each M.2 SSD is newly plugged in the system, a power-on initialization process is performed on the M.2 SSD to generate a power identifier based on the M.2 SSD itself, the way of generation may include, but is not limited to: the firmware of the M.2 SSD generates a set of codes based on the hard disk information inside the M.2 SSD upon the power-on of the M.2 SSD, with the codes functioning as an initial code of the power identifier (indicating working normally). The current value of the power identifier of the M.2 SSD is a second value indicating that the M.2 SSD itself works normally; it should be understood that the second value corresponds to the initial value as given above.

In step S530, the power identifier of the second M.2 SSD is recorded.

In this embodiment, the power identifier set for the newly hot plugged M.2 SSD is recorded.

By this, for each M.2 SSD that is newly hot plugged, an initial value of the power identifier of the M.2 SSD is set and recorded, to facilitate subsequent real time monitor on whether there is a need of hot unplug of the M.2 SSD based on the initial value.

In a possible implementation, after step S530, for the second M.2 SSD, the method shown in FIG. 1 may be executed to monitor, in real time, whether the second M.2 SSD needs to be hot unplugged.

In this embodiment, the method shown in FIG. 1 may be executed for each M.2 SSD that is newly hot plugged, so that problems of data loss and hard disk damage during the hot unplug of the M.2 SSD can be avoided.

In a possible implementation, the power identifier of the second M.2 SSD includes a power status bit indicating a power status of the second M.2 SSD, wherein the power status bit in the power identifier of the second M.2 SSD is switched in response to a change of the power status of the second M.2 SSD.

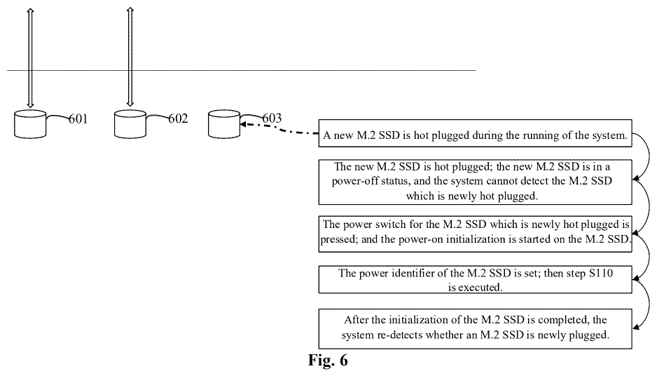

For ease of understanding, a hot plug process of an M.2 SSD of the present embodiment is described in detail below with reference to FIG. 6. As shown in FIG. 6, in total two M.2 SSDs 601 and 602 are plugged in the NVMe RAID card; the M.2 SSD 603, which is newly plugged by the user currently, is taken as an example to illustrate a process of new hot plug of any M.2 SSD in the NVMe RAID card.

During the running of the user system or the storage system using the SSD itself, the user has a new M.2 SSD 603 hot plugged in the system. That is, on the premise that the host or the system does not need to be powered down, the user has a new M.2 SSD 603 hot plugged in the system. When the user has a new M.2 SSD 603 hot plugged in the system, the M.2 SSD 603 is in a power-off status, and the system cannot detect the hot plug of the M.2 SSD 603. The user then presses the power switch associated with the M.2 SSD 603, and in response the power-on initialization process is executed on the M.2 SSD 603.

In this embodiment, the power-on initialization may include, but is not limited to: generating a power identifier of the M.2 SSD 603, recording the generated power identifier, setting an LED indicator associated with the M.2 SSD 603 to an off status, setting a beeper associated with the M.2 SSD 603 to a non-vibration status, recording a plug/unplug log corresponding to the M.2 SSD 603, sending an event notification indicating that the M.2 SSD 603 is newly hot plugged, and the like.

Next, in the power-on initialization, the power identifier of the M.2 SSD 603 is set, and the detection on a change of the power identifier of the M.2 SSD 603 is started; that is, the steps shown in FIG. 1 are executed.

In this embodiment, the program inside the M.2 SSD 603 detects the hard disk information of the M.2 SSD 603 generates a unique power identifier of the M.2 SSD 603, which is not shared with other M.2 SSDs, based on the hard disk information and the power status (on status) of the M.2 SSD 603; when the power status of the M.2 SSD 603 changes, the program inside the M.2 SSD 603 switches the power status bit in the power identifier of the M.2 SSD 603.

After the power-on initialization of the M.2 SSD 603 is finished, the user system or the storage system detects whether there is an M.2 SSD newly hot plugged.

According to the present embodiment, when the M.2 SSD is newly hot plugged in the user system or the storage system, the power identifier of the M.2 SSD is set, and the association among the power identifier, the LED indicator, and the power switch is recorded; when the plugged M.2 SSD is unplugged from the system, it is monitored whether the power identifier of the M.2 SSD changes, to determine the M.2 SSD on which a hot unplug is to be performed; the corresponding LED indicator is determined using the power identifier of the M.2 SSD and the association, to prompt the user of the M.2 SSD on which the hot unplug is to be performed; and in response to the prompt, the user can turn off the corresponding power switch and then hot unplug the M.2 SSD.

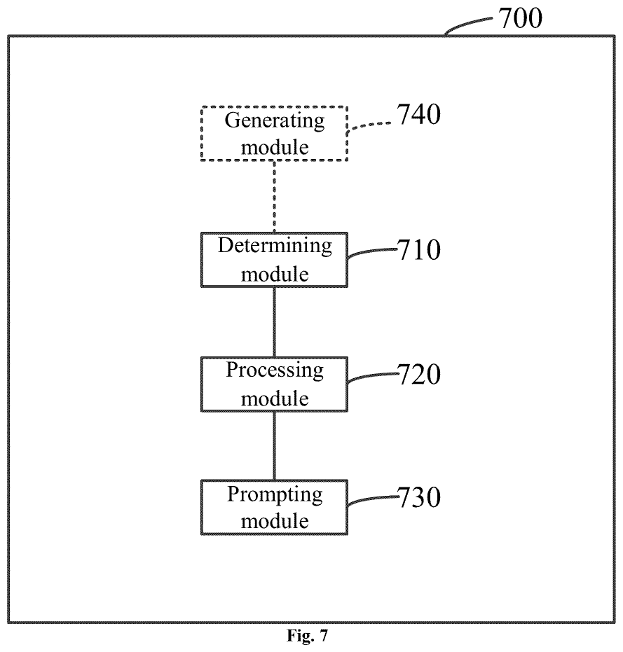

FIG. 7 shows a block diagram of an M.2 SSD hot plug/unplug processing apparatus 700 according to an embodiment of the present disclosure. As shown in FIG. 7, the device 700 may include a determining module 710, a processing module 720, and a prompting module 730. The determining module 710 determines, based on the power identifier of the first M.2 SSD that is plugged in the target apparatus, whether a hot unplug operation is required to be performed on the first M.2 SSD; the processing module 720 is connected to the determining module 710 and is configured to cause, if the determining module 710 determines that a hot unplug operation is required to be performed on the first M.2 SSD, the first M.2 SSD to enter a read-only mode indicating that the first M.2 SSD cannot receive a new writing request from the target apparatus, and to continue to complete a writing operation for an old writing request that has been received from the target apparatus; and the prompting module 730 is connected to the processing module 720 and is configured to prompt a user that a hot unplug operation can be currently performed on the first M.2 SSD.

In a possible implementation, the determining module 710 is configured to: obtain a power identifier of the first M.2 SSD in real time; determine whether a currently obtained value of the power identifier is a first value indicating that a hot unplug operation needs to be performed on the first M.2 SSD; and if it is determined that the obtained value of the power identifier is the first value, determine that the hot unplug operation needs to be performed on the first M.2 SSD.

In a possible implementation, the determining module 710 is configured to: obtain a power identifier of the first M.2 SSD in real time; determine whether a value of a currently obtained power identifier is consistent with a value of a power identifier that is set for the first M.2 SSD when the first M.2 SSD is powered on and initialized; and if the values are inconsistent, determine that a hot unplug operation needs to be performed on the first M.2 SSD.

In a possible implementation, the processing module 720 is configured to: if it is determined that a hot unplug operation needs to be performed on the first M.2 SSD, enable the first M.2 SSD to enter the read-only mode, and determine whether first data written into a temporary storage module exists in data corresponding to the old write request; and if it is determined that the first data exists, write the first data stored in the temporary storage module into a flash memory of the first M.2 SSD, to continue to complete a write operation for the old write request, where after the write operation for the old write request is completed, the prompting module 730 prompts the user that a hot unplug operation can be currently performed on the first M.2 SSD.

In a possible implementation, the prompt module 730 is configured to: after the writing operation for the old writing request is completed, cause the first M.2 SSD to enter a quasi-hot unplug mode from the read-only mode, and perform the prompting, wherein the quasi-hot unplug mode is a mode indicating that data cannot be written into the first M.2 SSD and hot unplugging of the first M.2 SSD from the target apparatus by the user is waited.

In a possible implementation, the power identifier of the first M.2 SSD includes a power status bit indicating a power status of the first M.2 SSD, and correspondingly, the processing module 720 is further configured to switch the power status bit of the power identifier of the first M.2 SSD in response to the user turning off the power switch associated with the first M.2 SSD based on the prompt.

In a possible implementation, the prompt includes at least one of: lighting up an indicator light associated with the first M.2 SSD; causing an acoustic component associated with the first M.2 SSD to emit a prompting tone; causing a vibration component associated with the first M.2 SSD to vibrate; notifying a user that a hot unplug operation can be performed on the first M.2 SSD; and displaying, to the user, an event that a hot unplug operation can be performed on the first M.2 SSD.

In a possible implementation, the above device 700 further includes: a generating module 740 configured to: in response to the power switch associated with the second M.2 SSD that is newly hot plugged in the target apparatus being turned on, generate and record a power identifier of the second M.2 SSD based on the hard disk information of the second M.2 SSD and the power status of the second M.2 SSD, where a current value of the power identifier of the second M.2 SSD is a second value indicating that the second M.2 SSD works normally; and then the determining module 710 performs the above determination on the second M.2 SSD.

In a possible implementation, the power identifier of the second M.2 SSD includes a power status bit indicating a power status of the second M.2 SSD, wherein the power status bit in the power identifier of the second M.2 SSD is switched in response to a change of the power status of the second M.2 SSD.

In some embodiments, functions or modules included in the device provided in the embodiments of the present disclosure may be used to execute the method described in the above method embodiments, and for specific implementation thereof, reference may be made to the descriptions of the above method embodiments, and for brevity, details are not described herein again.

An embodiment of the present disclosure further provides an electronic device, including a memory, a processor, and computer program stored on the memory, the processor executes the computer program to implement the steps of the above method.

An embodiment of the present disclosure further provides a non-volatile computer-readable storage medium on which a computer program is stored, and the computer program implements, when executed by a processor, the steps of the above method.

An embodiment of the present disclosure further provides a computer program product including computer program or a non-volatile computer-readable storage medium carrying computer program, wherein the computer program implements, when executed by a processor, the steps of the above method.

The flowcharts and block diagrams in the figures illustrate the system architectures, functions, and operations of possible implementations of the systems, methods and computer program products according to various embodiments of the present disclosure. In this regard, each block in the flowcharts or block diagrams may represent one module, program segment, or portion of instructions, which comprises one or more executable instructions for implementing the specified logical function(s). In some alternative implementations, the functions noted in the blocks may occur out in an order different from that noted in the figures. For example, two consecutive blocks may, in fact, be executed substantially concurrently, or the blocks may sometimes be executed in a reversed order, depending upon the functions involved. It will also be noted that each block of the block diagrams and/or flowchart, and combinations of blocks in the block diagrams and/or flowchart, can be implemented by dedicated hardware-based systems that execute specified functions or acts, or can be implemented by combinations of dedicated hardware and computer instructions.

The various embodiments of the present disclosure have been described above, which are exemplary but not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical applications, or technical improvement over technologies found in the marketplace, or to enable others of ordinary skill in the art to understand the embodiments disclosed herein.

1. An M.2 SSD hot plug/unplug processing method, wherein the method includes:
determining, based on a power identifier of a first M.2 SSD plugged in a target apparatus, whether a hot unplug operation is required to be performed on the first M.2 SSD;
causing, in response to determining that the hot unplug operation is required to be performed on the first M.2 SSD, the first M.2 SSD to enter a read-only mode indicating that the first M.2 SSD cannot receive a new writing request from the target apparatus, and continuing to complete a writing operation for an old writing request that has been received from the target apparatus; and
prompting a user that the hot unplug operation can be currently performed on the first M.2 SSD.

2. The method according to claim 1, wherein, the determining comprises:
obtaining the power identifier of the first M.2 SSD in real time;
determining whether a value of a currently obtained power identifier is a first value indicating that the hot unplug operation is required to be performed on the first M.2 SSD; and
in response to determining that the obtained value of the power identifier is the first value, it is determined that the hot unplug operation is required to be performed on the first M.2 SSD.

3. The method according to claim 1, wherein, the determining comprises:
obtaining a power identifier of the first M.2 SSD in real time;
determining whether a value of a currently obtained power identifier is consistent with a value of a power identifier set for the first M.2 SSD upon power-on initialization of the first M.2 SSD; and
in response to determining to be inconsistent, it is determined that the hot unplug operation is required to be performed on the first M.2 SSD.

4. The method according to claim 1, wherein the causing comprises:
in response to determining that the hot unplug operation needs to be performed on the first M.2 SSD, enabling the first M.2 SSD to enter the read-only mode, and determining whether first data written into a temporary storage module exists in data corresponding to the old write request;
in response to determining that the first data exists, writing the first data stored in the temporary storage module into the first M.2 SSD flash memory to continue to complete the write operation for the old write request,
wherein the prompting is performed after the writing operation for the old writing request is completed.

5. The method according to claim 1, wherein the prompting comprises:
after the writing operation for the old writing request is completed, causing the first M.2 SSD to enter a quasi-hot unplug mode from the read-only mode and performing the prompting, wherein the quasi-hot unplug mode is a mode indicating that data cannot be written into the first M.2 SSD and awaiting hot unplugging of the first M.2 SSD from the target apparatus by the user.

6. The method according to claim 1, wherein,
the power identifier of the first M.2 SSD comprises a power status bit indicating a power status of the first M.2 SSD, and the method further comprises:
switching the power status bit of the power identifier of the first M.2 SSD in response to a user turning off a power switch associated with the first M.2 SSD based on the prompt.

7. The method according to claim 1, wherein the prompting comprises at least one of:
lighting up an indicator light associated with the first M.2 SSD;
causing an acoustic component associated with the first M.2 SSD to emit a prompting tone;
causing a vibrating component associated with the first M.2 SSD to vibrate;
notifying the user that the hot unplug operation can be performed on the first M.2 SSD; or
displaying to the user an event that the hot unplug operation can be performed on the first M.2 SSD.

8. The method according to claim 1, wherein the method further comprises:
in response to a power switch associated with a second M.2 SSD which is newly hot-plugged in the target apparatus being turned on, generating and recording the power identifier of the second M.2 SSD based on hard disk information of the second M.2 SSD and a power status of the second M.2 SSD, wherein a current value of the power identifier of the second M.2 SSD is a second value indicating that the second M.2 SSD works normally; and
determining, based on the power identifier of a the second M.2 SSD plugged in the target apparatus, whether the hot unplug operation is required to be performed on the second M.2 SSD.

9. The method according to claim 8, wherein,
the power identifier of the second M.2 SSD comprises a power status bit indicating a power status of the second M.2 SSD, wherein the power status bit in the power identifier of the second M.2 SSD is switched in response to a change of the power status of the second M.2 SSD.

10. The method according to claim 1, wherein the target apparatus comprises an NVMe RAID card or a host.

11. An electronic device including a memory, a processor, and computer program stored on the memory, wherein the processor executes the computer program to:
determine, based on a power identifier of a first M.2 SSD plugged in a target apparatus, whether a hot unplug operation is required to be performed on the first M.2 SSD;
cause, in response to determining that the hot unplug operation is required to be performed on the first M.2 SSD, the first M.2 SSD to enter a read-only mode indicating that the first M.2 SSD cannot receive a new writing request from the target apparatus, and continuing to complete a writing operation for an old writing request that has been received from the target apparatus; and
prompt a user that the hot unplug operation can be currently performed on the first M.2 SSD.

12. (canceled)

13. A computer program product, comprising computer program, or a non-transitory computer-readable storage medium carrying the computer program, wherein the computer program, when executed by a processor, implements:
determining, based on a power identifier of a first M.2 SSD plugged in a target apparatus, whether a hot unplug operation is required to be performed on the first M.2 SSD;
causing, in response to determining that the hot unplug operation is required to be performed on the first M.2 SSD, the first M.2 SSD to enter a read-only mode indicating that the first M.2 SSD cannot receive a new writing request from the target apparatus, and continuing to complete a writing operation for an old writing request that has been received from the target apparatus; and
prompting a user that the hot unplug operation can be currently performed on the first M.2 SSD.
